(19) United States
(12) Patent Application Publication
(10) Pub. No.: US 2004/0032383 A1
(43) Pub. Date: Feb. 19, 2004

(54) Power-saving liquid crystal display and operation method of the same

(75) Inventor: Li-Sen Chuang, Penghu (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Toppoly Optoelectronics Corp., Miao-Li County (TW)

(21) Appl. No.: 10/420,481

(22) Filed: Apr. 22, 2003

(30) Foreign Application Priority Data
Aug. 13, 2002 (TW) 091118219

(51) Int. Cl. G09G 3/36

(52) U.S. Cl. 345/87

(57) ABSTRACT

An operation method of a liquid crystal display (LCD) is disclosed. The LCD includes a light-reflective electrode and an active matrix including at least one liquid-crystal pixel unit. The operation method includes steps of providing a multi-level operational voltage signal to the liquid-crystal pixel unit when liquid-crystal molecules in the liquid-crystal pixel unit are in a first steady state, and asserting a switch signal to the liquid-crystal pixel unit to change the configuration of the liquid-crystal molecules from the first steady state into a second steady state. A transmittance of the liquid-crystal pixel unit varies with the multi-level operational voltage signal in the first steady state, and maintains at a constant level in the second steady state. In addition, a power-saving LCD is also disclosed.

### FIELD OF THE INVENTION

The present invention relates to a liquid crystal display (LCD), and more particularly to a power-saving liquid crystal display. The present invention also relates to an operation method of a liquid crystal display (LCD) for achieving the power-saving purpose.

### BACKGROUND OF THE INVENTION

For portable electronic appliances, e.g. electronic watches, pocket calculators, personal digital assistants (PDAs) and cell phones, liquid crystal displays (LCDs) are the most popular displays for revealing the information. Currently, the LCD types include light-penetrative, light-reflective, partially light-penetrative and partially light-reflective LCDs.

Please refer to FIGS. 1A and 1B which are schematic cross-sectional diagrams showing a conventional light-reflective LCD structure without and with applied voltage, respectively. The LCD structure comprises of a polarizer plate 10, a wide-band quarter wave plate 11, a transparent top glass plate 12, a transparent top electrode 13, a liquid crystal layer 14, a light-reflective electrode layer 15 and a transparent bottom glass plate 16.

In a portion of the LCD structure of FIG. 1A, there is no voltage applied between the light-reflective electrode layer 15 and the transparent top electrode 13. The liquid-crystal molecules in the liquid crystal layer 14 are in an initial state and delay light passing therethrough twice by a phase difference 2d. The light penetrating through the wide-band quarter wave plate 11 and the liquid crystal layer 14 is reflected by the light-reflective electrode layer 15, and then passes through the liquid crystal layer 14 and the wide-band quarter wave plate 11 again. Therefore, the overall phase difference of the light is the sum of a quarter wavelength, the phase difference 2d and another quarter wavelength, respectively resulting from the delaying effects of the wide-band quarter wave plate 11, twice of the liquid crystal layer 14 and the wide-band quarter wave plate 11 again. That is, the overall phase difference is a half wavelength plus 2d, and the light delayed by a half wavelength plus 2d will reflect to the observer's eyes. Meanwhile, the display is all-bright. On the other hand, when a voltage is applied between the light-reflective electrode layer 15 and the transparent top electrode 13, the liquid crystal molecules in the liquid crystal layer 14 will become upright, as shown in FIG. 1B. When all the liquid crystal molecules are upright, the light-phase delaying effect of the liquid crystal layer 14 will be diminished, i.e. d=0. Accordingly, the overall phase difference becomes a half wavelength. The light with such phase difference is not allowed to reach the observer's eyes, and thus this display will be all-dark.

The wide-band quarter wave plate is conventionally provided by overlapping a quarter wave plate and a half wave plate. In order to achieve the wide-band function and make the light within a certain wavelength range have a phase difference of a quarter wavelength, the relationship among the slow axes S1 and S2 of the quarter and the half wave plates and the transmission axis T of the bottom polarizer plate or the top polarizer plate is required to be in a certain manner, for example as shown in FIG. 2.

When the electronic appliance with the light-reflective LCD leaves unused for a while and in a stand-by status, it is preferred that the LCD enter a hold type for saving power. In other words, the LCD reveals a fixed frame without refreshment. For revealing the fixed frame on the LCD, a static random access memory (SRAM) is conventionally built-in the pixel unit of the LCD. However, the top and bottom substrates beside the liquid crystal layer still need to continuously receive alternate-current (AC) signals to allow the liquid crystal molecules to normally operate in this situation. Because it is necessary to continuously provide the AC signal to the top and bottom substrates, power consumption cannot be totally exempted from even under the hold type. Therefore, the power-saving efficiency is limited.

Therefore, the purpose of the present invention is to develop a liquid crystal display capable of revealing a fixed frame in a stand-by status with no power consumption, so as to deal with the above situations encountered in the prior art.

### SUMMARY OF THE INVENTION

An object of the present invention is to provide a power-saving liquid crystal display (LCD), which includes a liquid crystal layer changing no transmittance and thus consuming no power in a stand-by status.

Another object of the present invention is to provide an operation method of a liquid crystal display (LCD), which displays the same frame without refreshment in a stand-by status.

According to an aspect of the present invention, there is provided an operation method of a liquid crystal display (LCD). The LCD includes a light-reflective electrode and an active matrix including at least one liquid-crystal pixel unit. The operation method includes steps of providing a multilevel operational voltage signal to the liquid-crystal pixel unit when liquid-crystal molecules in the liquid-crystal pixel unit are in a first steady state, and asserting a switch signal to the liquid-crystal pixel unit for changing the configuration of the liquid-crystal molecules from the first steady state into a second steady state. A transmittance of the liquid-crystal pixel unit varies with the multi-level operational voltage signal in the first steady state, and maintains at a constant level in the second steady state.

For example, an initial configuration of the liquid-crystal molecules in the liquid-crystal pixel unit in the first steady state can be a homogeneous mode, a hybrid mode, a bend mode or a tilt mode.

Preferably, the liquid-crystal molecules in the liquid-crystal pixel unit in the second steady state has a twisted angle of 180 degrees from an initial configuration thereof.

Preferably, the configuration of the liquid-crystal molecules is changed in response to a voltage drop of the switch signal from a high voltage to a low voltage. Preferably, the low voltage is a zero voltage and the high voltage is larger than a maximum of the multi-level operational voltage.

According to another aspect of the present invention, there is provided a power-saving liquid crystal display (LCD). The power-saving LCD includes a top substrate structure including a top electrode and a half wave plate, a bottom substrate structure including a bottom electrode, a liquid crystal layer disposed between the top electrode and the bottom electrode and equivalent to a quarter wave plate, a transmittance of the liquid crystal layer being adjusted in response to a multi-level operational voltage in a first steady state, and being constant in a second steady state, and a signal generator electrically connected to the top and bottom electrodes for generating a switch signal to the top and bottom electrodes to change the configuration of the liquid-crystal molecules in the liquid crystal layer from the first steady state to the second steady state.

Preferably, the top substrate structure further includes a light-penetrative substrate, and a polarizer plate disposed above a first surface of the light-penetrative substrate, and sandwiching the half wave plate therebetween with the light-penetrative substrate. The top electrode is preferably a light-penetrative common electrode formed on a second surface of the light-penetrative substrate. The light-penetrative common electrode is preferably formed of indium tin oxide.

For example, the light-penetrative substrate can be a glass substrate.

Preferably, the bottom electrode includes a light-reflective electrode layer. For example, the light-reflective electrode layer is formed of aluminum or silver. Preferably, the bottom substrate structure comprises a substrate having a first surface formed the light-reflective electrode layer thereon.

Preferably, the configuration of the liquid-crystal molecules is changed in response to a steep falling edge of the switch signal. The falling edge preferably indicates a voltage drop from a voltage higher than a maximum voltage of the multi-level operational voltage to a zero voltage.

Preferably, the liquid-crystal molecules in the liquid-crystal pixel unit have a twisted angle of 180 degrees from an initial configuration thereof in the second steady state.

Preferably, the signal generator further generates a recover signal for switching the liquid-crystal molecules in the liquid crystal layer from the second steady state to the first steady state. The recover signal is preferably a triangle-waveform signal.

Preferably, the signal generator is disposed in a driving device of the LCD.

### BRIEF DESCRIPTION OF THE DRAWINGS

The present invention may best be understood through the following description with reference to the accompanying drawings, in which:

FIGS. 1A and 1B are schematic cross-sectional diagrams showing a conventional light-reflective LCD structure without and with applied voltage, respectively;

FIG. 2 is a schematic diagram illustrating the relationship among the slow axes S1 and S2 of the quarter and the half wave plates and the transmission axis T of the bottom polarizer plate or the top polarizer plate;

FIG. 3 is a schematic cross-sectional diagram illustrating a preferred embodiment of a power-saving liquid crystal display (LCD) structure according to the present invention;

FIG. 4 is a schematic diagram illustrating the configuration difference of liquid-crystal molecules between the operation status and the stand-by status according to the present invention; and

FIGS. 5A and 5B are reflectivity vs. wavelength plots of two power-saving examples of the LCD, respectively, according to the present invention.

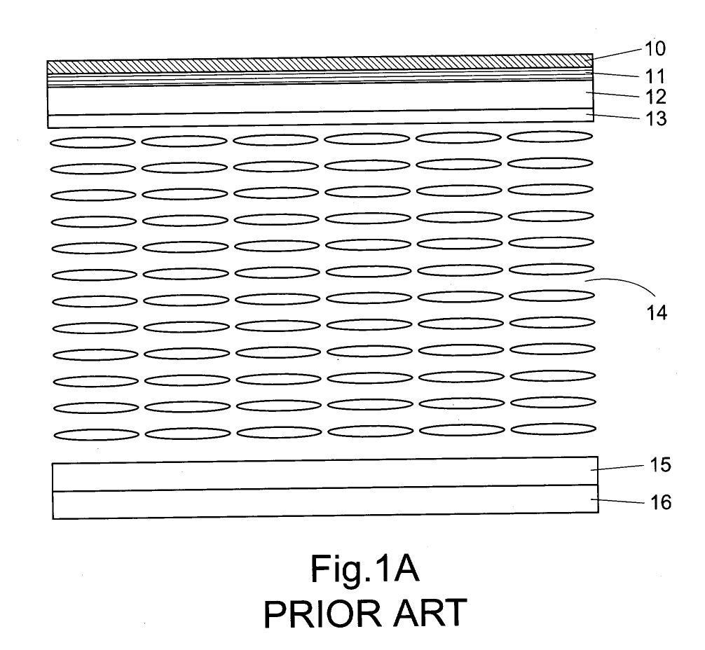

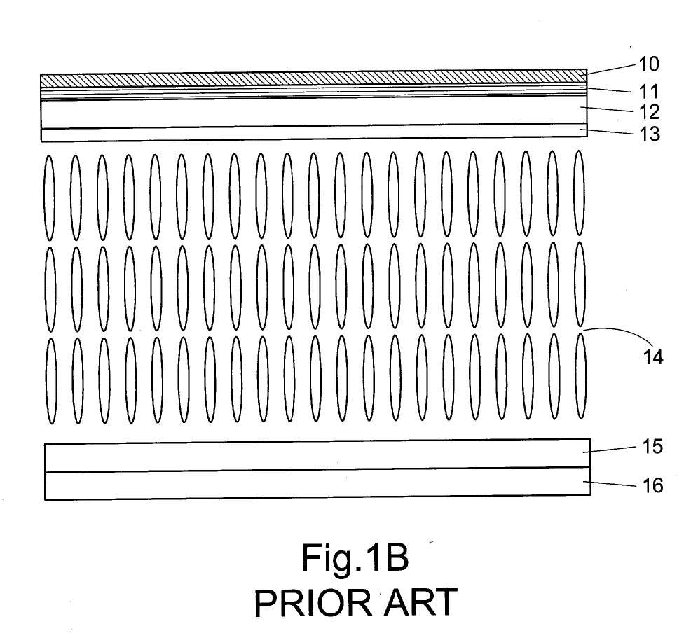

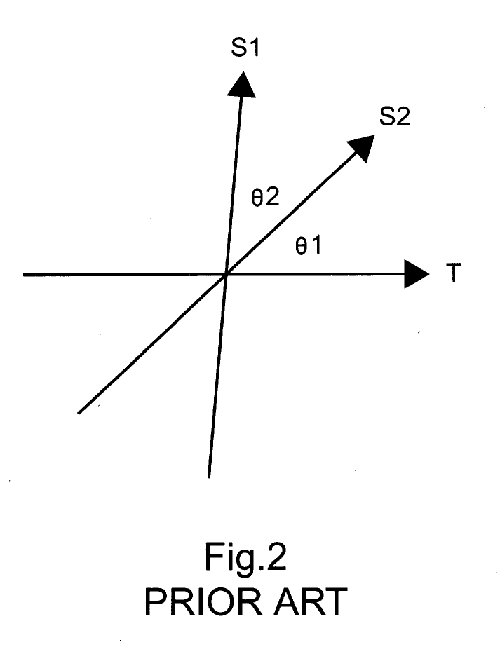

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

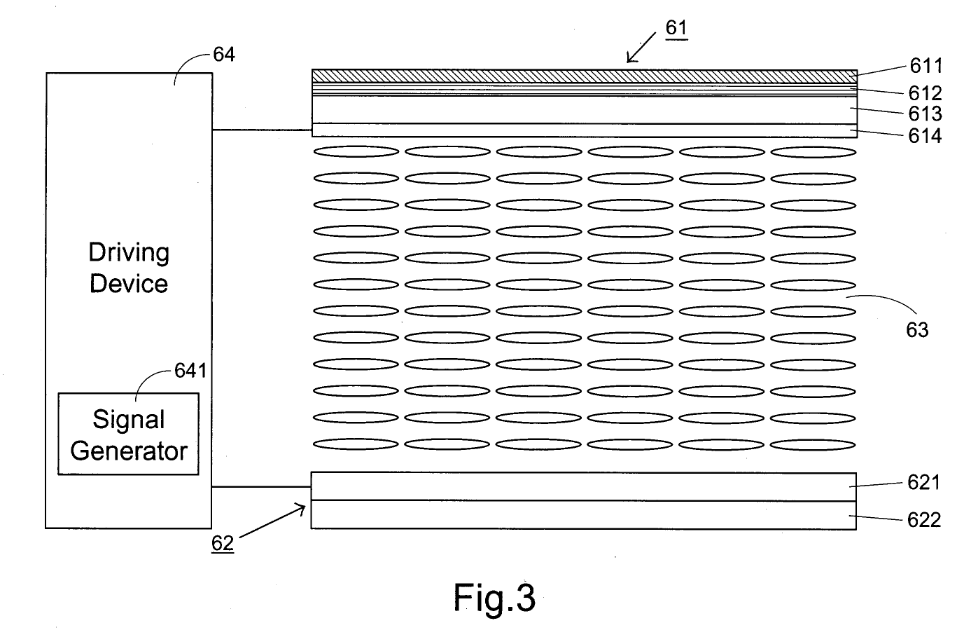

Please refer to FIG. 3 which schematically shows a power-saving liquid crystal display (LCD) according to the present invention. The power-saving LCD includes a top substrate structure 61, a bottom substrate structure 62, a liquid crystal layer 63 and a driving device 64 including a signal generator 641. The top substrate structure 61 includes a polarizer plate 611, a half wave plate 612, a light-penetrative substrate 613 and a light-penetrative common electrode 614, and the bottom substrate structure 62 includes a light-reflective electrode 621 and a substrate 622. The polarizer plate 611 is disposed on the top of the first surface of the light-penetrative substrate 613 and the half wave plate 612 is disposed between the first surface of the light-penetrative substrate 613 and the polarizer plate 611. The common electrode 614 is formed on the second surface of the substrate 613 and the light-reflective electrode 621 is formed on the surface of the substrate 622. The liquid crystal layer 63 is located between the light-penetrative common electrode 614 and the light-reflective electrode 621. The liquid crystal layer 63 is made equivalent to a quarter wave plate by properly adjusting the thickness of the liquid crystal layer 63, i.e. the distance between the light-penetrative common electrode 614 and the light-reflective electrode 621.

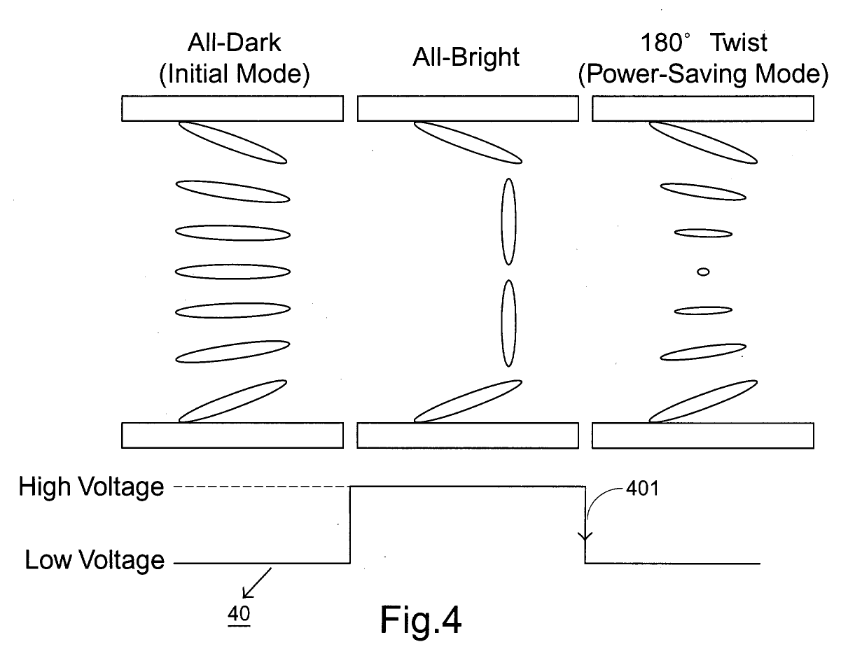

The operation method of the liquid crystal display (LCD) is described hereinafter with reference to the devices of FIG. 3 in view of FIG. 4 that schematically shows the configuration change of the liquid crystal molecules. For displaying an image on the LCD, multi-level operational voltage signals are provided to liquid-crystal pixel units of the LCD in an operation state. The transmittance of the liquid-crystal pixel units vary with respective multilevel operational voltage signals, thereby adjusting gray levels or colors of the image displayed on the LCD.

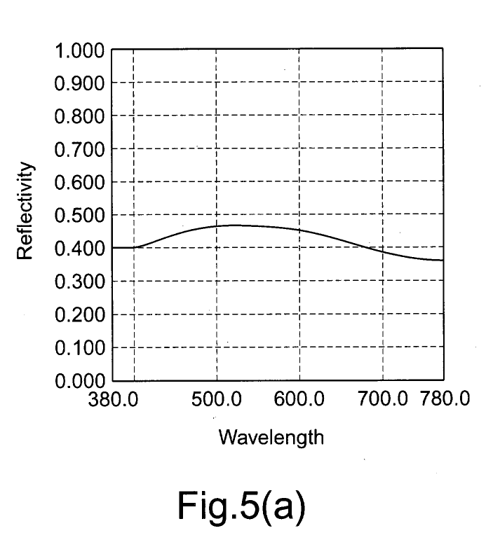

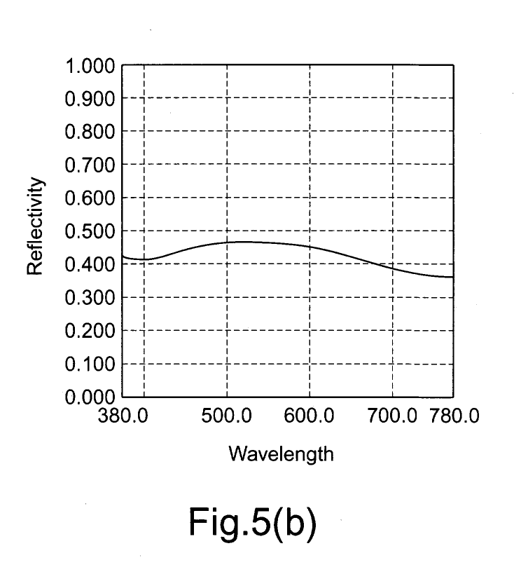

When the LCD has displayed the same picture for a certain period and enters a stand-by status, a power-saving mode according to the present invention is enabled. Meanwhile, the displayed picture is frozen with a fixed frame, i.e. without refreshment. In order to achieve this purpose, a switch signal 40 is asserted by the signal generator 641 to the liquid-crystal pixel units. For those dark pixels, the switch signal 40 maintains at a low voltage level, e.g. 0 volt. On the other hand, for the bright pixels, the switch signal 40 is discharged from a high voltage to a low voltage, as indicated by the numeral reference 401, to change the configuration of the liquid-crystal molecules. The high voltage of the switch signal is preferably set to be higher than the maximum value of the multi-level operational voltages. In the power-saving mode, the configuration of the liquid-crystal molecules is twisted by 180 degrees from an initial configuration thereof. The initial configuration of the liquid-crystal molecules can be a homogeneous mode, a hybrid mode, a bend mode or a tilt mode. The specific configuration of the liquid crystal molecules in the power-saving mode, i.e. clockwise or counterclockwise 180-degree twist, allows the bright pixels to remain bright, while no voltage supply is required. FIGS. 5A and 5B demonstrate the bright status of the power-saving configurations of the liquid crystal molecules that are clockwise and counterclockwise twisted by 180 degrees, respectively. In this way, the LCD only reveals a fixed frame and need not be refreshed in the stand-by status, so the power-saving purpose can be achieved.

In an example, the light-penetrative substrates 613 and 622 as shown in FIG. 3 are both glass substrates. The light-penetrative common electrode 614 is made of indium tin oxide (ITO). The material of the light-reflective electrode 621 is preferably aluminum or silver.

The present invention can be widely applied to various LCDs incorporating normally black and normally white display.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An operation method of a liquid crystal display (LCD), said LCD comprising a light-reflective electrode and an active matrix including at least one liquid-crystal pixel unit, said operation method comprising steps of:
providing a multi-level operational voltage signal to said liquid-crystal pixel unit when liquid-crystal molecules in said liquid-crystal pixel unit are in a first steady state; and
asserting a switch signal to said liquid-crystal pixel unit for changing a configuration of said liquid-crystal molecules from said first steady state into a second steady state,
wherein a transmittance of said liquid-crystal pixel unit varies with said multi-level operational voltage signal in said first steady state, and maintains at a constant level in said second steady state.

2. The operation method according to claim 1 wherein an initial configuration of said liquid-crystal molecules in said liquid-crystal pixel unit in said first steady state is one selected from a group consisting of a homogeneous mode, a hybrid mode, a bend mode and a tilt mode.

3. The operation method according to claim 1 wherein said liquid-crystal molecules in said liquid-crystal pixel unit in said second steady state has a twisted angle of 180 degrees from an initial configuration thereof.

4. The operation method according to claim 1 wherein said second steady state is enabled in response to a voltage drop of said switch signal from a high voltage to a low voltage.

5. The operation method according to claim 4 wherein said low voltage is a zero voltage.

6. The operation method according to claim 4 wherein said high voltage is larger than a maximum of said multi-level operational voltage.

7. A power-saving liquid crystal display (LCD), comprising:
a top substrate structure including a top electrode and a half wave plate;
a bottom substrate structure including a bottom electrode;
a liquid crystal layer disposed between said top electrode and said bottom electrode and equivalent to a quarter wave plate, a transmittance of said liquid crystal layer being adjusted in response to a multi-level operational voltage in a first steady state, and being constant in a second steady state; and
a signal generator electrically connected to said top and bottom electrodes for generating a switch signal to said top and bottom electrodes to change the configuration of said liquid-crystal molecules in said liquid crystal layer from said first steady state to said second steady state.

8. The power-saving liquid crystal display according to claim 7 wherein said top substrate structure further comprising:
a light-penetrative substrate; and
a polarizer plate disposed above a first surface of said light-penetrative substrate, and sandwiching said half wave plate therebetween with said light-penetrative substrate.

9. The power-saving liquid crystal display according to claim 8 wherein said top electrode is a light-penetrative common electrode formed on a second surface of said light-penetrative substrate.

10. The power-saving liquid crystal display according to claim 9 wherein said light-penetrative common electrode is formed of indium tin oxide.

11. The power-saving liquid crystal display according to claim 8 wherein said light-penetrative substrate is a glass substrate.

12. The power-saving liquid crystal display according to claim 7 wherein said bottom electrode includes a light-reflective electrode layer.

13. The power-saving liquid crystal display according to claim 12 wherein said light-reflective electrode layer is formed of a material selected from a group consisting of aluminum and silver.

14. The power-saving liquid crystal display according to claim 12 wherein said bottom substrate structure comprises a substrate having a first surface formed said light-reflective electrode layer thereon.

15. The power-saving liquid crystal display according to claim 7 wherein the configuration of said liquid-crystal molecules in said liquid crystal layer is changed in response to a steep falling edge of said switch signal.

16. The power-saving liquid crystal display according to claim 15 wherein said falling edge indicates a voltage drop from a voltage higher than a maximum voltage of said multi-level operational voltage to a zero voltage.

17. The power-saving liquid crystal display according to claim 7 wherein said liquid-crystal molecules in said liquid-crystal pixel unit has a twisted angle of 180 degrees from an initial configuration thereof in said second steady state.

18. The power-saving liquid crystal display according to claim 7 wherein said signal generator further generates a recover signal for switching said liquid-crystal molecules in said liquid crystal layer from said second steady state to said first steady state.

19. The power-saving liquid crystal display according to claim 18 wherein said recover signal is a triangle-waveform signal.

20. The power-saving liquid crystal display according to claim 7 wherein said signal generator is disposed in a driving device of said LCD.
